(19) United States
(12) Patent Application Publication
(10) Pub. No.: US 2021/0229827 A1
(43) Pub. Date: Jul. 29, 2021

(54) THERMAL MANAGEMENT SYSTEM AND METHOD OF USING SAME

(71) Applicant: Government of the United States, as represented by the Secretary of the Air Force, Wright-Patterson AFB, OH (US)

(72) Inventor: David B. Doman, Springfield, OH (US)

(73) Assignee: Government of the United States, as represented by the Secretary of the Air Force, Wright-Patterson AFB, OH (US)

(21) Appl. No.: 17/110,448

(22) Filed: Dec. 3, 2020

Related U.S. Application Data
(62) Division of application No. 15/285,701, filed on Oct. 5, 2016.
(60) Provisional application No. 62/238,996, filed on Oct. 8, 2015.

(51) Int. Cl. B64D 37/34; F02C 7/224

(52) U.S. Cl. CPC B64D 37/34; F02C 7/224

(57) ABSTRACT

A thermal management system for an aircraft and method of using same are provided. The system includes a fuel reservoir, a fuel recirculation loop, a fuel mixing valve, and a control module. The fuel recirculation loop includes a fuel recirculation tank, heat exchanger that transfers waste thermal energy to the fuel, and another heat exchanger that transfers waste thermal energy out of the heated fuel. The fuel recirculation loop supplies heated fuel to a combustion engine and is configured to return a portion of the heated fuel to the recirculation tank via a return line. The fuel mixing valve fluidly couples the fuel reservoir and the fuel recirculation tank to provide a mixture of the two fuel sources based on the temperature of the heated fuel. The thermal management system increases an aircraft thermal endurance over that which can be attained by a single tank fuel flow topology.

### CROSS-REFERENCE TO RELATED APPLICATIONS

The present application claims priority to U.S. Provisional Patent Application Ser. No. 62/238,996 filed on Oct. 8, 2015, and 62/397,501 filed on Sep. 21, 2016, and U.S. Non-Provisional application Ser. No. 15/285,701, each of which is incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The application relates generally to thermal management systems for combustion engine systems, and more particularly, to a thermal management system for an aircraft and a method for improving thermal endurance of the thermal management system.

### BACKGROUND OF THE INVENTION

Problems associated with aircraft heat dissipation have typically been confined to aircraft that operate at high Mach numbers where high speed contributes to frictional heating of the aircraft outer skin. However, thermal issues are beginning to occur on modern subsonic and supersonic aircraft as well, but the source of this heat energy is principally generated by sources internal to the aircraft. Onboard avionics, mission systems, electromechanical actuators, electronic engine accessories, pumps, engine components, and weapon systems can generate a significant amount of waste thermal energy that must ultimately be dissipated to the environment external to the aircraft.

One reason that heating is becoming an issue is that the composite skin on new aircraft does not conduct heat as well as the metal skin of previous generations of aircraft. Additionally, in the future, directed energy weapons may generate pulsed thermal loads that will likely be temporarily stored using the thermal capacitance of fluids on board the aircraft before ultimately being transferred to the atmosphere over a longer period of time.

A common method for transporting waste thermal energy from heat sensitive components on aircraft is to actively cool them using vapor cycle systems (VCS) or air cycle systems (ACS) internal to the aircraft. These energy transport systems transfer waste thermal energy to the fuel as the fuel flows from a fuel storage tank through a feed line before the fuel is eventually consumed by an engine or an auxiliary power unit (APU). Often the fuel flow rate required to maintain fuel temperatures within operating limits exceeds the fuel flow rate required to power the aircraft. In such cases, unburned fuel is returned to the fuel storage tank along with a quantity of waste thermal energy, in a so-called “single tank fuel flow topology.”

Depending upon ambient conditions, unburned fuel can be returned directly to the fuel storage tanks, and in some instances, after having passed through a cooler to facilitate transfer of a portion of the accumulated thermal energy from recirculated fuel to the environment external to the aircraft (i.e., the atmosphere). Fuel storage tank temperature can therefore change with time as specific internal energy increases or decreases as a result of heated or cooled fuel being returned to the tank. Under certain operating conditions, a typical cooler is unable to transfer more thermal energy from the fuel to the atmosphere than the thermal energy that was added to the fuel by the internal systems. Accordingly, in this single tank fuel flow topology, fuel tank temperature and/or recirculation loop temperature may eventually exceed thermal and/or operability limits (e.g., fuel coking limits), and exceeding these thermal limits may damage subsystems or possibly result in aircraft loss.

Accordingly, the performance of the entire thermal management system of the aircraft may be affected by both continuous and discrete components, and decisions made early in flight can significantly affect the time and range to a thermal limit. Thus, because the ability of an aircraft to accomplish thermally stressful missions can be limited by the ability to remove heat from aircraft subsystems, new methods and systems are needed.

### SUMMARY OF THE INVENTION

The present invention overcomes one or more of the foregoing problems and other shortcomings, drawbacks, and challenges of prior art thermal managements systems. While the invention will be described in connection with certain embodiments, it will be understood that the invention is not limited to these embodiments. To the contrary, this invention includes all alternatives, modifications, and equivalents as may be included within the spirit and scope of the present invention.

In accordance with an embodiment of the present invention, a thermal management system for an aircraft is provided that comprises a fuel reservoir, a fuel recirculation loop, a fuel mixing valve, and a control module. The fuel recirculation loop comprises a fuel recirculation tank, a first heat exchanger that transfers waste thermal energy from at least one system component to the fuel to provide a heated fuel, and a second heat exchanger that transfers waste thermal energy out of the heated fuel. The fuel recirculation loop supplies heated fuel to a fuel injector of a combustion engine and is configured to return a portion of the heated fuel to the recirculation tank via a return line. The fuel mixing valve fluidly couples the fuel reservoir and the fuel recirculation tank. And the control module is configured to control a mixing ratio of fuel flowing from the fuel reservoir and the fuel recirculation tank. The mixing ratio is a function of a temperature of the heated fuel flowing from the first heat exchanger to the fuel injector. The thermal management system for the aircraft increases an aircraft thermal endurance over that which can be attained by a single tank fuel flow topology.

In accordance with another embodiment, a thermal management system for an aircraft is provided that includes a) a fuel reservoir having a first temperature sensor that provides a reservoir fuel temperature; b) a fuel recirculation loop comprising a fuel recirculation tank, a first heat exchanger, a second heat exchanger, and a partitioning valve; c) a fuel mixing valve fluidly coupling the fuel reservoir and the fuel recirculation tank, wherein an outlet of the fuel mixing valve is fluidly coupled to an inlet of the first heat exchanger; and d) a control module configured to control a mixing ratio of fuel flowing from the fuel reservoir and the fuel recirculation tank, wherein the mixing ratio is a function of the heated fuel temperature flowing from the first heat exchanger. The fuel recirculation tank includes a second temperature sensor that provides a recirculation fuel temperature, and a quantity sensor that provides a recirculation fuel mass or a recirculation fuel volume contained within the fuel recirculation tank. The first heat exchanger comprises a first inlet, a first outlet, a first fuel side, a heated fluid side, a first heat transfer barrier physically separating the first fuel side and the heated fluid side, and a first outlet temperature sensor that provides a heated fuel temperature. The partitioning valve is fluidly coupled to the first outlet of the first heat exchanger to partition heated fuel flow between a combustion engine inlet and a return line that returns fuel to the fuel recirculation tank. And the second heat exchanger comprises a second inlet, a second outlet, a second fuel side, a cooling fluid side, and a second heat transfer barrier physically separating the second fuel side and the cooling fluid side, wherein optionally a portion of the heated fuel in the return line flows through the second heat exchanger before returning to the fuel recirculation tank. The thermal management system for the aircraft increases an aircraft thermal endurance over that which can be attained by a single tank fuel flow topology.

In accordance with yet another embodiment of the present invention, a method for managing thermal energy of an aircraft is provided, where the method includes recirculating fuel through a thermal management system that includes a fuel storage tank; a fuel recirculation loop comprising a fuel recirculation tank, and a first heat exchanger that transfers waste thermal energy from at least one system component to the fuel to provide a heated fuel, the loop supplying heated fuel to fuel injector of a combustion engine, and returning a portion of the heated fuel to the recirculation tank via a return line; a fuel mixing valve fluidly coupling the fuel storage tank and the fuel recirculation tank; and a control module configured to control a mixing ratio of fuel flowing from the fuel storage tank and the fuel recirculation tank, wherein the mixing ratio is a function of the heated fuel temperature flowing from the first heat exchanger to the fuel injector; and mixing a predetermined ratio of a first portion of fuel from the fuel storage tank, and second portion of fuel from the fuel recirculation tank, wherein the predetermined ratio is a function of the heated fuel temperature. This method increases an aircraft thermal endurance over that which can be attained by a single tank fuel flow topology.

Additional objects, advantages, and novel features of the invention will be set forth in part in the description and drawings which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with the summary given above, and the detailed description given below, serve to explain the invention. It will be appreciated that, for purposes of clarity and where deemed appropriate, reference numerals have been repeated in the figures to indicate corresponding features.

FIG. 1 is a schematic showing a simplified thermal management system for an aircraft, in accordance with an embodiment of the present invention;

FIG. 2 is a schematic showing another simplified thermal management system for an aircraft, in accordance with another embodiment of the present invention; and

FIG. 3 is a schematic showing another simplified thermal management system for an aircraft along with assigned variables to designate mass (m), mass transfer rates (\dot{m}), temperatures (T), internal energies (U), and thermal energy transfer rates (Q̅) at various points in the system, in accordance with another embodiment of the present invention.

### DETAILED DESCRIPTION OF THE INVENTION

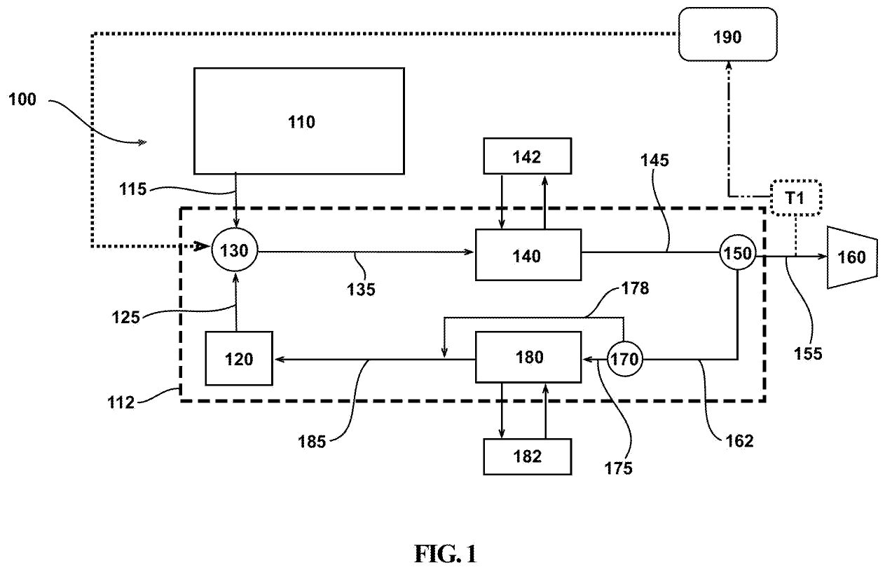

Aircraft without a dedicated heated fuel recirculation tank can recirculate heated fuel back to a reservoir where the concentrated energy in the heated fuel is free to diffuse throughout the colder fuel in the reservoir. This process gradually increases the temperature of the fuel in the reservoir and over time, the rate at which fuel temperature grows increases due to a steadily decreasing mass of fuel. The net onboard waste energy in an aircraft using such a strategy is higher than it would be using the present invention because fuel passing through a fuel injector to the environment generally contains a lower concentration of thermal energy than it would when using the present invention. The use of a dedicated heated fuel recirculation tank, as described herein and shown in FIGS. 1-3, prevents the unnecessary diffusion of thermal energy through a cold reservoir and allows high temperature fuel from the recirculation tank to be blended with cold fuel from a reservoir such that the disposal rate of thermal energy to the environment is improved and may be maximized.

Thus, in accordance with an embodiment of the present invention and in reference to FIG. 1, a simplified fuel thermal management system 100 for an aircraft is provided that comprises a fuel reservoir 110, a heated fuel recirculation loop 112 that includes a heated fuel recirculation tank 120, a controllable fuel mixing valve 130, a first heat exchanger 140, a partitioning valve 150 that partitions fuel flow between an inlet 155 of a fuel injector of a combustion engine 160 and a return line 162, a bypass valve 170, a second heat exchanger 180, and a control module 190.

The heated fuel recirculation tank 120 is a container that accommodates a defined volume of heated fuel that is separate and distinct from the fuel reservoir 110. Generally, during operation the heated fuel recirculation tank 120 contains fuel that is at a significantly higher temperature than the fuel in the fuel reservoir 110. In an embodiment, the temperature of the fuel within the fuel reservoir 110 is within a range from just above its freezing temperature to below the temperature of the fuel in the recirculation tank 120. During operation the temperature of the fuel contained in the recirculation tank 120 is within a range from just above the temperature of the fuel in the reservoir 110 to a temperature that is sufficiently below a fuel coking temperature to allow absorption of the waste thermal energy in the first heat exchanger 140 without exceeding the fuel coking temperature at the outlet.

In accordance with embodiments of the present invention, a ratio between the volumes of the reservoir 110 and the recirculation tank 120 is about 1:1 or more so as to benefit from a purpose of maximizing the disposal of waste thermal energy through the injection ports of the combustion engine 160. For example, the volume ratio of the reservoir 110 to the recirculation tank 120 may be about 1:1 or more, about 2:1 or more, about 3:1 or more, about 4:1 or more, about 5:1 or more, about 7:1 or more, about 10:1 or more, about 15:1 or more, about 20:1 or more, about 25:1 or more, about 35:1 or more, or about 50:1 or more, or within a range between any two of the foregoing.

Still referring to FIG. 1, jet fuel, which serves as a coolant in the fuel thermal management system 100, flows from the controllable mixing valve 130 via the first heat exchanger feed line 135 and enters the first heat exchanger 140 where waste thermal energy is absorbed from at least one aircraft system component 142. The mass flow rate of the fuel entering the feed line 135 of the heated fuel recirculation loop 112 should be sufficient to avoid exceeding a thermal limit (e.g., the fuel coking temperature) at the exit of the first heat exchanger 140, as well as supply the needs of the combustion engine 160 and maintain a desired amount of heated fuel in the recirculation tank 120.

As used herein, the term “jet fuel” refers to a type of fuel for a gas-turbine engine in an aircraft. Jet fuel generally contains a range of hydrocarbons, which may have different characteristics, such as a number of carbons, molecular weight, decomposition temperatures, and freezing temperatures. In certain embodiments, the jet fuel may be a combustible hydrocarbon liquid fuel. In certain embodiments, the jet fuel may be a kerosene fuel, with includes hydrocarbons with carbon numbers typically ranging between C8 and C16, generally comprising alkanes, cycloalkanes, aromatic hydrocarbons such as alkylbenzenes and alkylnaphthalenes (double ring), and/or olefins. Jet fuel is typically hydrocarbon-based and therefore may demonstrate thermal degradation via an auto-oxidation pathway with oxygen dissolved in the fuel. To minimize thermal degradation at elevated temperatures and increase its coking temperature, jet fuel is generally de-oxygenated, and may further contain very low amounts of contaminants, such as metals or heteroatomic ligands. The fuel may also include additives that increase the fuel coking temperature (i.e., increase thermal stability).

The first heat exchanger 140 includes an inlet, an outlet, a fuel side, a heated fluid side 145, a first heat transfer barrier physically separating the first fuel side and the heated fluid side, and temperature sensors (e.g., inlet and outlet). The aircraft system component(s) 142 can be actively cooled by using vapor cycle systems (VCS) or air cycle systems (ACS) internal to the aircraft that absorbs the waste thermal energy into a fluid, which then transfers the waste thermal energy from the heated fluid to the jet fuel to produce a heated fuel. Accordingly, the first heat exchanger 140 functions as a heat sink for cooling the aircraft system components 142, and as a heater for the fuel.

Depending on the fuel demand of the combustion engine 160, the heated fuel 145 exiting the first heat exchanger 140 is partitioned between a fuel injector of the combustion engine 160 and a return line 162, which returns a portion of the heated fuel to the heated fuel recirculation tank 120. Some of the waste thermal energy contained in the heated fuel may be transferred out of the fuel using a second heat exchanger 180 to achieve a desired fuel temperature in the recirculation tank 120.

The second heat exchanger 180 includes an inlet, an outlet, a fuel side, a cooling fluid side, and a heat transfer barrier physically separating the fuel side and the cooling fluid side. But prior to entering the second heat exchanger 180, the heated fluid flows through a bypass valve 170, which permits fuel to bypass the heat exchanger 180 via the second heat exchanger bypass loop 178. Any bypass flow rejoins the fuel flowing out of the second heat exchanger 180 and enters the heated recirculation tank 120 via a recirculation tank inlet line 185. The waste thermal energy removed from the heated fuel in the second heat exchanger 180 can be transferred to the external air (i.e., the cooling fluid).

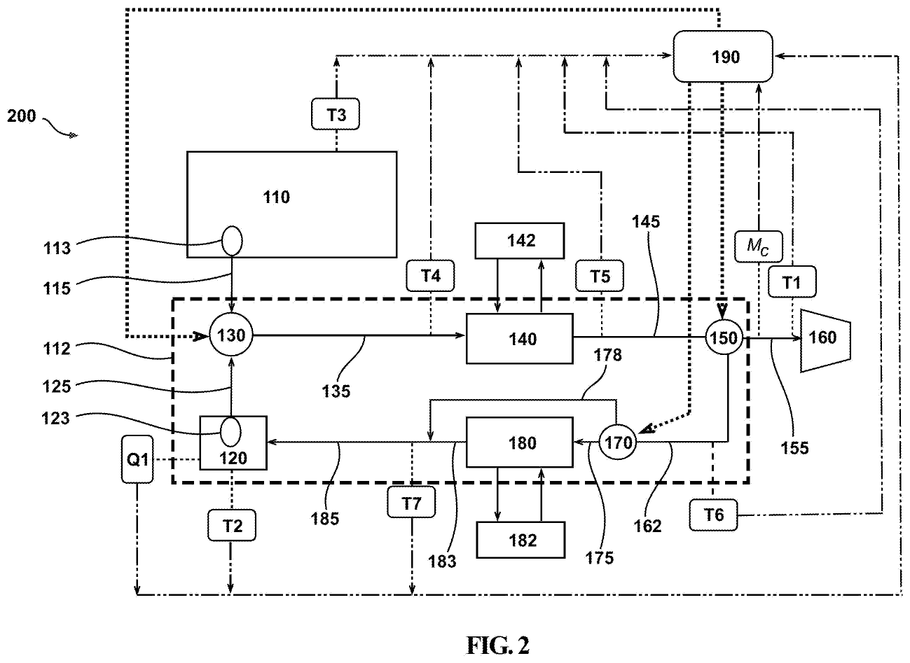

As shown in FIG. 1, the control module 190 is configured to control at least the controllable fuel mixing valve 130 to control a mixing ratio of fuel flowing from the fuel reservoir 110 (through a fuel reservoir outlet line 115) and the heated fuel recirculation tank 120 (through a fuel recirculation tank outlet line 125). In accordance with embodiments of the present invention, the mixing ratio is a function of the heated fuel temperature flowing from the first heat exchanger 140 (see e.g., T1 in FIG. 1). Additionally as shown in FIG. 2, the control module 190 may also monitor other temperature sensors (e.g., T2-T7), mass flow sensors (e.g., M_{c}), and/or fuel quantity sensors (e.g., Q1 providing a volume or mass) throughout various locations in the fuel thermal management system 200, and then send commands to valves, pumps, and mixers.

In one aspect, the control module 190 may operate to regulate fuel temperatures to levels at or below operational limits such that the concentration of thermal energy in the fuel passing through the fuel injection port of the combustion engine 160 is as high as possible to maximize the rate at which thermal energy is transported from the aircraft to the environment. Thus, the primary objective of the control module 190 is to increase or maximize the disposal rate of waste thermal energy.

A secondary objective of the control module 190 can be to minimize the fraction of power applied to a pump that is converted to waste heat. The strategy for achieving the secondary objective is strongly dependent upon how the pump is powered, (e.g., direct drive from an engine, electrically powered, variable speed, etc.).

The fraction of power applied to a fuel pump that is converted to waste thermal energy is influenced by mass flow rate and pump speed. For typical jet engine fuel pumps, the pump impeller is geared to the spool of the engine and flow is throttled using valves. The more the flow is throttled, the more of the power applied to the impeller is converted to waste heat. The control module 190 can adopt a sub-objective in this case of minimizing the use of throttle valves in order to reduce the amount of heat added to the fuel by a pump. This is consistent with a flow rate maximization strategy.

Employing a variable speed pump to control the flow of fuel, as well as minimizing flow rates through the heated fuel recirculation loop 112, would be consistent with minimizing power usage and the conversion of useful power to waste heat in the fuel. For example, as shown in FIG. 2, fuel being fed from the fuel reservoir 110 and the heated fuel recirculation tank 120 could be controlled by individual variable speed control pumps 113, 123, respectively.

In accordance with the embodiment shown in FIG. 2, there may be three regulated outputs: 1) feed line temperature (e.g., T4); 2) exit temperature (e.g., T5 or T1) of the first heat exchanger 140; and 3) fuel mass (e.g., Q1) in heated fuel recirculation tank 120. Additionally, there can be three inputs that can be manipulated by the control module 190 to regulate the outputs to desired set-points: 1) feed line mass flow rate (e.g., controlling variable speed pumps 113, 123, or an unregulated pump with a controllable throttle valve, not shown); 2) mixing valve 130 position (e.g., controls proportion of fuel entering the feed line 135 from the fuel reservoir 110 and the heated fuel recirculation tank 120); and 3) bypass valve 170 position (e.g., controls proportion of the recirculated fuel allowed to pass through second heat exchanger 180 (i.e., a cooler)). In accordance with an aspect of the present invention, the control module 190 monitors differences between outputs and set-points and manipulates the inputs such that the differences are driven towards zero.

In accordance with another embodiment, an overflow loop could be present that would connect the heated fuel recirculation loop 112 to the fuel reservoir 110 to accommodate situations where operation in non-equilibrium conditions could cause the heated fuel recirculation tank 120 to overflow. Such a situation is not ideal and pushes the thermal management problem down the road as the fuel reservoir temperature (T3) starts to increase. Nevertheless, this may be necessary to complete some missions even though it decreases overall thermal endurance. This feature, which is not shown in the figures, could be implemented as a safety valve that opens and allows the recirculation tank 120 to overflow into the fuel reservoir 110.

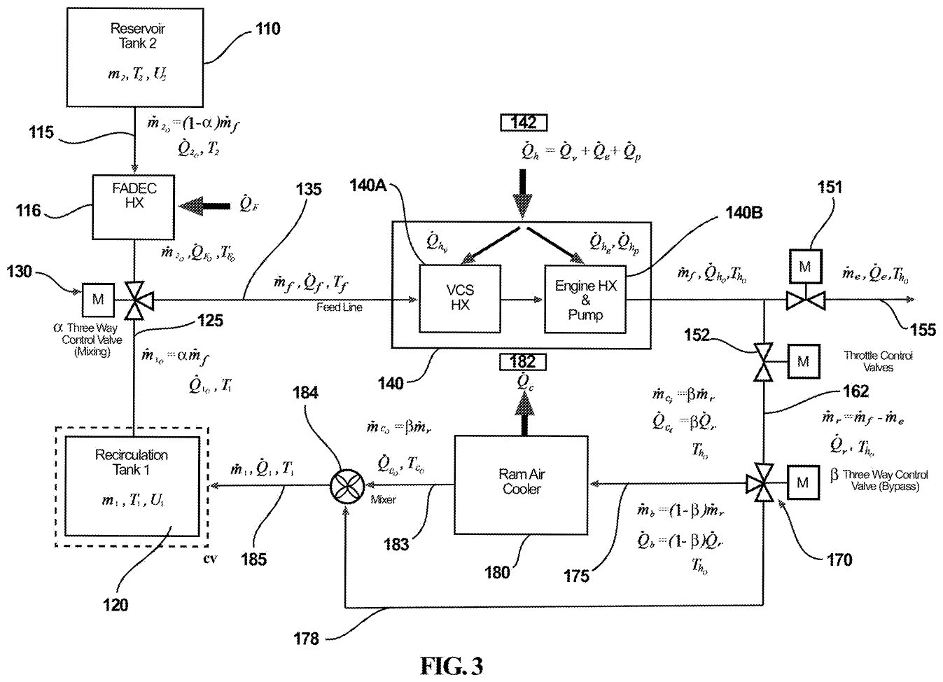

In yet another dual tank system embodiment, illustrated in FIG. 3, a fuel thermal management system is shown that includes assigned variables to designate mass (m), mass transfer rates (\dot{m}), temperatures (T), internal energies (U), and thermal energy transfer rates (Q̅) at various points in the system. Fuel flowing from reservoir tank 110 may be preheated prior to flowing into the controllable fuel mixing valve 130. For example, heat (Q̅_{F}) from a Full Authority Digital Engine Controller (FADEC) may be transferred to fuel via a FADEC heat exchanger 116. The FADEC has the lowest temperature limit (T_{F}) in the fuel system and therefore has been placed directly at the output of the insulated reservoir tank that contains the coldest fuel. This implies that flow from the reservoir tank 110 must be non-zero in order to provide adequate cooling for the FADEC. The outlet flow of fuel from the FADEC heat exchanger 116 is then mixed with flow from the recirculation tank 120 that generally contains fuel at a different temperature (T₁) from that held within the reservoir tank 110 (T₂). The relative flow rates from the reservoir tank 110 and recirculation tank 120, (\dot{m}₂ and \dot{m}₁, respectively) are governed by the controllable fuel mixing valve 130 that is composed of a pair of throttle valves and a mixer. The flow (\dot{m}_{f}) is assumed to be well mixed (at a temperature T_{f}) as it enters the first heat exchanger feed line 135. The parameter αϵ[0; 1] represents the position of the control valve 130 that governs the proportion of fuel entering the feed line that originates from the recirculation tank 120. A value of α=1 indicates that all fuel entering the feed line originates from the recirculation tank, while a value of α=0 indicates that all fuel entering the feed line originates from the reservoir.

A vapor cycle system (VCS) is used for transferring thermal power from the aircraft electrical subsystems and the fuel via the VCS heat exchanger 140A. The power transferred to the fuel from the VCS is denoted as Q̅ₕᵥ and depends upon the number of aircraft subsystems that are operating at any given time and the temperature of the heat transfer fluids. Refrigerant in the VCS transfers thermal energy from electrical components to fuel by a separately controlled hot side evaporation, compression, and condensation cycle. Another heat exchanger (140B) in FIG. 3 represents the thermal energy transferred to the fuel by a jet engine, and more specifically an engine lubrication system and fuel pump. Thermal energy from the engine lubrication system and fuel pump is transferred to the fuel at a rate of Q̅ₕₑ and Q̅ₕₚ respectively.

After the fuel flow exits the heat exchangers (140A and 140B), one throttle valve (e.g., 150, shown FIGS. 1 and 2) or two throttle valves (e.g., 151 and 152, shown in FIG. 3) control the fuel mass flow rate to the fuel injectors in the engine, \dot{m}ₑ, and the flow rate that is passed through the recirculation loop, \dot{m}ᵣ. From the conservation of mass:

\dot{m}ᵣ=\dot{m}_{f}−\dot{m}ₑ Equation (1)

A pilot of the aircraft regulates \dot{m}ₑ by manipulating the cockpit throttle setting, which is an exogenous input or disturbance from the point of view of an aircraft fuel thermal management control system. The fuel flow in the recirculation loop can pass through the second heat exchanger 180 (e.g., a ram air cooler) or be returned directly to the recirculation tank 120. A control valve 170, whose position is designated as βϵ[0; 1], governs the proportion of the recirculated flow that passes through the heat exchanger 180. When β=1, all of the recirculating flow is directed through the cooler; when β=0, the cooler is completely bypassed. The fuel flow from the bypass loop 178 and the outlet 183 of the second heat exchanger 180 are mixed (mixer 184) prior to entering the recirculation tank 120. The behavior of the bulk mean temperature (T₁) of the fuel in the recirculation tank 120 is of primary interest as it influences the range of temperatures that can be achieved at all points throughout the fuel system. The recirculation tank temperature (T₁) is governed by a first order time varying ordinary differential equation.

Thermal Power Contributions from Heat Exchangers and Fuel Pump: Thermal power (Q̅) transferred to the fuel through the FADEC, VCS, and engine heat exchangers are taken to be specified for a given mission segment. Heating of the fuel due to pumping inefficiencies is dependent upon the type of pump(s) present in the fuel loop. Historically, jet engine fuel pumps have been of the centrifugal type. These pumps are typically integrated into the engine and are powered by the spool via a transmission. The speed of the fuel pumps and the power applied to them is a function of the engine speed, which is in turn governed by throttle setting, altitude, and Mach number of the aircraft. Because these pumps are designed to achieve a specified pressure for a rated flow and speed; any variability about the design condition decreases pump efficiency and increases the fraction of the power applied to the pump that is converted into waste thermal power in the fuel.

In a mathematical simulation, a small recirculation tank 120 (containing about 200 kg fuel) and a large reservoir tank 110 (containing 2850 kg fuel) are each equipped with variable speed fuel pumps (e.g., 113, 123 in FIG. 2) that deliver fuel to a servo driven mixing valve 130 which modulates fuel flow rate (\dot{m}_{f}) and the recirculation tank/reservoir tank fuel ratio (\dot{m}2₀/\dot{m}1₀ or [1−α]/α). The fuel mixture is directed from the mixing valve 130 through a feed line 135 where the feed line temperature (T_{f}) is monitored by a temperature sensor. The output of the feed line temperature sensor is connected to a feedback control system via a sensor bus. Fuel passes through the feed line to one or more heaters (140), where refrigerant may pass through an evaporator that absorbs waste thermal energy from onboard systems and then a compressor and condenser that raises the temperature of the refrigerant such that waste thermal energy can be transferred to the fuel flowing through the heater 140. A temperature sensor in the fuel line at the heater exit is connected to a feedback controller. A portion of the fuel in the line is directed to the aircraft engine fuel injectors according to the throttle setting of valve 151. Fuel not directed the fuel injector enters a recirculation line 162 via a throttle valve 152.

The recirculation line is directed to a servo driven wye valve 170 that controls the proportion of recirculated fuel through an atmospheric cooler 180 via line 175 and the proportion of fuel that is passed directly back to the recirculation tank 120 via bypass line 178. A cooler bypass override switch monitors temperatures of the cooler wall and the fuel exiting the heater and can direct all recirculated fuel directly to the recirculation tank 120, by adjustment of valve 170, if the cooler wall temperature exceeds the temperature of the recirculated fuel. If the bypass valve 170 is not activated, the control of the servo bypass valve may be directed by the closed loop feedback control system.

The cooler 180) is a heat exchanger that allows waste thermal energy from the fuel to be transferred to the atmosphere (e.g., 182). Servo valves and pumps may be connected to the feedback controller via an actuator command bus. A level sensor or fuel mass sensor in the recirculation tank may be connected to the feedback control system via a sensor bus. The feedback controller compares the feed line (T_{f}) and heater exit (Th₀) temperatures, as well as the recirculation tank mass level (m₁), to those specified by a mission planner or set point generator and adjusts the commands to the actuators to regulate the system to the set point. The feedback controller also processes the recirculation tank temperature sensor measurement as this state can also contribute in the feedback control even though it may not be specifically regulated. The feedback controller includes a bank of summers, multipliers, and integrators that can be implemented on embedded digital or analog electronic hardware. The mission planner and set point generator can be as simple as a table stored in memory or an online mission optimization algorithm that is used to generate feasible set points for the control system that maximize waste thermal energy disposal rates through the engine fuel injectors.

As used herein and in the appended claims, the singular forms “a”, “an” and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

It will be understood that when an element is described as being “connected” or “coupled” to or with another element, it can be directly connected or coupled to the other element or, instead, one or more intervening elements may be present. In contrast, when an element is described as being “directly connected” or “directly coupled” to another element, there are no intervening elements present. When an element is described as being “indirectly connected” or “indirectly coupled” to another element, there is at least one intervening element.

While the present invention has been illustrated by the description of one or more embodiments thereof, and while the embodiments have been described in considerable detail, they are not intended to restrict or in any way limit the scope of the appended claim to such detail. Additional advantages and modification will be readily apparent to those skilled in the art. The invention in its broader aspects is therefore not limited to the specific details, representative apparatus and methods and illustrative examples shown and described. Accordingly, departures may be made from such details without departing from the scope or the spirit of the general inventive concept exemplified herein.

What is claimed is:

1. A method for managing thermal energy of an aircraft, comprising:
recirculating fuel through a thermal management system comprising:
a fuel storage tank;
a fuel recirculation loop comprising a fuel recirculation tank, and a first heat exchanger that transfers waste thermal energy from at least one system component to the fuel to provide a heated fuel, the fuel recirculation loop supplying heated fuel to a fuel injector of a combustion engine, and returning a portion of the heated fuel to the recirculation tank via a return line;
a controllable fuel mixing valve fluidly coupling the fuel storage tank and the fuel recirculation tank; and
a control module configured to control a mixing ratio of fuel flowing from the fuel storage tank and the fuel recirculation tank, wherein the mixing ratio is a function of the heated fuel temperature flowing from the first heat exchanger to the fuel injector; and
mixing a predetermined ratio of a first portion of fuel from the fuel storage tank, and second portion of fuel from the fuel recirculation tank, wherein the predetermined ratio is a function of the heated fuel temperature,
wherein the control module is configured to regulate a plurality of outputs comprising a feed line temperature between the controllable fuel mixing valve and the first heat exchanger, an exit temperature of the first heat exchanger, and a fuel mass in the heated fuel recirculation tank to desired set-points, wherein the thermal management system for the aircraft increases an aircraft thermal endurance over that which can be attained by a single tank fuel flow topology.

2. The method of claim 1, further comprising:
flowing the heated fluid of the vapor cycle system through the heated fluid side of the first heat exchanger to transfer at least a portion of the waste thermal energy from the heated fluid to the fuel to provide the heated fuel.

3. The method of claim 1, wherein the control module is configured to receive input signals comprising:
a fuel mass flow rate required by the combustion engine,
a temperature difference across a first inlet temperature sensor and the first outlet temperature sensor of the first heat exchanger, and
a fuel quantity signal provided by the quantity sensor in the fuel recirculation tank; and wherein the control module is configured to provide output signals comprising:
a fuel feed rate that includes the mixing ratio of fuel flowing from the fuel storage tank and the fuel recirculation tank,
the partition ratio for heated fuel by the partition valve, which disperses heated fuel between the combustion engine and the return line to the fuel recirculation tank, and a splitting ratio of the heated fuel in the return line that flows through the second heat exchanger before returning to the recirculation tank versus a second heat exchanger bypass loop to achieve a set point value of the recirculation fuel temperature.

4. The method of claim 1, wherein the control module is configured to regulate a feed line mass flow rate with fuel pumps in the fuel reservoir and heated fuel recirculation tank, a mixing valve position controlling the proportion of fuel from the from the fuel reservoir and the heated fuel recirculation tank entering a feed line from the controllable fuel mixing valve, and a bypass valve position controlling a proportion of the recirculated fuel passing through a second heat exchanger to achieve desired set-points for the plurality of outputs.

5. The method of claim 1, wherein the control module is configured to divert, with a safety valve, heated fuel from the heated fuel recirculation tank to the fuel reservoir when the heated fuel recirculation tank is full.

6. The method of claim 1, wherein the control module is configured to drive a exit temperature from the first heat exchanger to within 10° C. or less below a coking temperature of the fuel.

7. A method for managing thermal energy of an aircraft, comprising:
recirculating fuel through a thermal management system comprising:
a fuel storage tank;
a fuel recirculation loop comprising a fuel recirculation tank, and a first heat exchanger that transfers waste thermal energy from at least one system component to the fuel to provide a heated fuel, the fuel recirculation loop supplying heated fuel to a fuel injector of a combustion engine, and returning a portion of the heated fuel to the recirculation tank via a return line;
a controllable fuel mixing valve fluidly coupling the fuel storage tank and the fuel recirculation tank; and
a control module configured to control a mixing ratio of fuel flowing from the fuel storage tank and the fuel recirculation tank, wherein the mixing ratio is a function of the heated fuel temperature flowing from the first heat exchanger to the fuel injector; and
mixing a predetermined ratio of a first portion of fuel from the fuel storage tank, and second portion of fuel from the fuel recirculation tank, wherein the predetermined ratio is a function of the heated fuel temperature,
wherein the control module is configured to drive a exit temperature from the first heat exchanger to within 10° C. or less below a coking temperature of the fuel.

8. The method of claim 1, further comprising:
flowing the heated fluid of the vapor cycle system through the heated fluid side of the first heat exchanger to transfer at least a portion of the waste thermal energy from the heated fluid to the fuel to provide the heated fuel.

9. The method of claim 1, wherein the control module is configured to receive input signals comprising:
a fuel mass flow rate required by the combustion engine,
a temperature difference across a first inlet temperature sensor and the first outlet temperature sensor of the first heat exchanger, and
a fuel quantity signal provided by the quantity sensor in the fuel recirculation tank; and wherein the control module is configured to provide output signals comprising:
a fuel feed rate that includes the mixing ratio of fuel flowing from the fuel storage tank and the fuel recirculation tank,
the partition ratio for heated fuel by the partition valve, which disperses heated fuel between the combustion engine and the return line to the fuel recirculation tank, and
a splitting ratio of the heated fuel in the return line that flows through the second heat exchanger before returning to the recirculation tank versus a second heat exchanger bypass loop to achieve a set point value of the recirculation fuel temperature.

10. The method of claim 1, wherein the control module is configured to regulate a plurality of outputs comprising a feed line temperature between the controllable fuel mixing valve and the first heat exchanger, an exit temperature of the first heat exchanger, and a fuel mass in the heated fuel recirculation tank to desired set-points.

11. The method of claim 10, wherein the control module is configured to regulate a feed line mass flow rate with fuel pumps in the fuel reservoir and heated fuel recirculation tank, a mixing valve position controlling the proportion of fuel from the from the fuel reservoir and the heated fuel recirculation tank entering a feed line from the controllable fuel mixing valve, and a bypass valve position controlling a proportion of the recirculated fuel passing through a second heat exchanger to achieve desired set-points for the plurality of outputs.

12. The method of claim 1, wherein the control module is configured to divert, with a safety valve, heated fuel from the heated fuel recirculation tank to the fuel reservoir when the heated fuel recirculation tank is full.
